(19) United States
(12) Patent Application Publication
(10) Pub. No.: US 2021/0342846 A1
(43) Pub. Date: Nov. 4, 2021

(54) SYSTEMS AND METHODS FOR PROCESSING FINANCIAL TRANSACTIONS USING COMPROMISED ACCOUNTS

(71) Applicant: Fidelity Information Services, LLC, Jacksonville, FL (US)

(72) Inventors: Jonathan BERGER, Slinger, WI (US); Charles CAPLAN, Ellicott City, MD (US); Rachael CHARLES, Glendale, WI (US); Jen CHILDRESS, Wauwatosa, WI (US); Steven FLAIG, Nashotah, WI (US); Andrew GATES, Maitland, FL (US); Trace HYBERTSON, Milwaukee, WI (US); Zebulon WOLLNER, West Bend, WI (US)

(73) Assignee: Fidelity Information Services, LLC

(21) Appl. No.: 16/862,344

(22) Filed: Apr. 29, 2020

(51) Int. Cl. G06Q 20/40; G06Q 40/02; G06Q 10/10; G06Q 20/32; G06Q 20/42; G06Q 30/00; G06Q 50/26; G06Q 20/10; H04L 9/08

(52) U.S. Cl. CPC G06Q 20/4016; G06Q 40/02; G06Q 10/107; G06Q 20/3267; H04L 9/085; G06Q 30/0185; G06Q 50/265; G06Q 20/108; G06Q 20/42

(57) ABSTRACT

Computer-implemented systems and methods for processing a financial transaction include receiving, from a device, a financial transaction comprising an account number associated with a financial account; based on a determination that the account number is suspended, determining whether authorization data associated with the financial account exists to authorize financial transactions associated with the account number after the account number is suspended; based on a determination that the authorization data exists, determining a first temporary identifier; receiving a second temporary identifier from the device; and based on a determination that the first temporary identifier is the same as the second temporary identifier, approving the financial transaction.

### TECHNICAL FIELD

The present disclosure generally relates to computerized methods and systems for processing financial transactions using a payment network and, more particularly, to computerized methods and systems for processing financial transactions using compromised accounts.

### BACKGROUND

Traditional payment networks are configured to process and enable financial transactions between various financial entities and merchants through the transfer of cash having a particular cash value. The transfer of cash or traditional cash-substitutes may be accomplished using negotiable instruments and/or electronic payment means including debit cards, credit cards, electronic fund transfers, etc. Each transfer thereof may be subject to procedures and protocols of a payment network based on one or more transaction rules associated with the payment network.

Data breaches becomes a rising threat to data security of financial accounts. When a data breach occurs, an account number (e.g., a credit or debit card number) of a user (e.g., an individual or a corporation) may be compromised and exposed to third parties, subject to potential unauthorized financial transactions. Traditional payment networks and financial service providers may protect the account number by detecting the data breach, identifying and freezing the compromised account number, declining all transactions under the compromised account number, and issuing a new account number to the user.

One problem with typical systems is that they cannot send the new account number to the user immediately. For example, the new account number may arrive in a physical form (e.g., a physical card) through a physical mail. Before receiving the new account number, the user can no longer use the compromised account number for financial transactions, such as point-of-sale transactions, online transactions, or recurring transactions. As a result, the user may experience an inconvenient and frustrating experience, especially when the user is unaware of the account number being frozen until a transaction is declined. Although some solutions may provide the new account number to the user using a digital wallet, the user is still limited to use the compromised account number in situations where physical cards are required. Further, the financial service provider that issues the new account number may risk losing a current customer because the user may choose to use another card in her wallet or even cancel the compromised account number and apply for a new account from another financial service provider to satisfy her speedy needs of financial transactions.

Therefore, a need exists in the financial service industry to temporarily enable a transaction to be processed under compromised accounts. The present disclosure is directed to addressing these and other challenges.

### SUMMARY

One aspect of the present disclosure is directed to a computer-implemented system. The system comprises a non-transitory computer-readable medium configured to store instructions and at least one processor configured to execute the instructions to perform operations. The operations include receiving, from a device, a financial transaction comprising an account number associated with a financial account; based on a determination that the account number is suspended, determining whether authorization data associated with the financial account exists to authorize financial transactions associated with the account number after the account number is suspended; based on a determination that the authorization data exists, determining a first temporary identifier; receiving a second temporary identifier from the device; and based on a determination that the first temporary identifier is the same as the second temporary identifier, approving the financial transaction.

Yet another aspect of the present disclosure is directed to another computer-implemented system. The system comprises a non-transitory computer-readable medium configured to store instructions and at least one processor configured to execute the instructions to perform operations. The operations include receiving, from a device, a notification indicating that an account number of a financial account is suspended; receiving, from the device, a request for authorization data authorizing financial transactions associated with the account number after the account number is suspended; based on user input, generating the authorization data; and transmitting the authorization data to the device.

Other aspects of the present disclosure are directed to computer-implemented methods for performing the functions of the computer-implemented systems discussed above.

Other systems, methods, and computer-readable media are also discussed herein.

### BRIEF DESCRIPTION OF THE DRAWINGS

FIG. 1 is a schematic diagram of an example system for processing a financial transaction, consistent with the disclosed embodiments.

FIG. 2 is a block diagram of an example server computer system for processing a financial transaction, consistent with the disclosed embodiments.

FIG. 3 is a block diagram of an example user device 110 shown in FIG. 1, consistent with the disclosed embodiments.

FIGS. 4A-4B depict example notifications presented on an apparatus used in the system shown in FIG. 1, consistent with the disclosed embodiments.

FIG. 5 depicts an example request presented on an apparatus used in the system shown in FIG. 1, consistent with the disclosed embodiments.

FIG. 6 depicts an example notification showing a replacement account number presented on an apparatus used in the system shown in FIG. 1, consistent with the disclosed embodiments.

FIG. 7 depicts an example notification showing a confirmation of authorization presented on an apparatus used in the system shown in FIG. 1, consistent with the disclosed embodiments.

FIG. 8 depicts an example notification showing a list of recurring transactions presented on an apparatus used in the system shown in FIG. 1, consistent with the disclosed embodiments.

FIG. 9 depicts an example temporary identifier presented on an apparatus used in the system shown in FIG. 1, consistent with the disclosed embodiments.

FIG. 10 is a flowchart of an example back-end process for processing a financial transaction in the system shown in FIG. 1, consistent with the disclosed embodiments.

FIG. 11 is a flowchart of an example front-end process for processing a financial transaction in the system shown in FIG. 1, consistent with the disclosed embodiments.

### DETAILED DESCRIPTION

The disclosed embodiments include systems and methods for processing financial transactions. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present example embodiments of the disclosure, examples of which are illustrated in the accompanying drawings. Wherever possible, the same reference numbers will be used throughout the drawings to refer to the same or like parts.

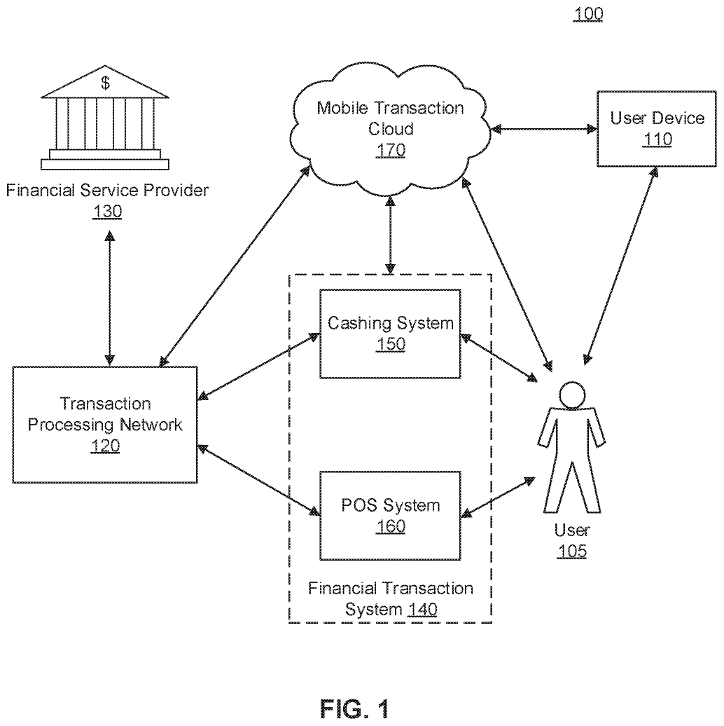

FIG. 1 is a schematic diagram illustrating an example system 100 for processing a financial transaction, consistent with the disclosed embodiments. For example, the financial transaction processed by system 100 may be in the form of check payments, debit card payments, credit card payments, electronic payment made through the Automated Clearing House (ACH) Network, Real-Time Payment Network, wire transfers, electronic payments, peer-to-peer payments, mobile payments (e.g., Apple Pay®), electronic fund payment (e.g., Zelle), or the like. Moreover, the payments processed by system 100 may include recurring payments, such as payments of utility bills, providing paychecks to an employee through direct deposits, mortgage payments, or the like. As shown in FIG. 1, system 100 includes transaction processing network 120, financial service provider 130, financial transaction system 140, and mobile transaction cloud 170.

In FIG. 1, transaction processing network 120 may include one or more computer systems associated with one or more financial entities, such as a financial service provider 130. Transaction processing network 120 may be an Interbank Network (such as NYCE®, INTERAC®, or the like). Interbank Networks allow money systems (such as ATMs or payment terminals) to access deposit or other accounts. In some embodiments, transaction processing network 120 may enable the use of ATM cards issued by a bank to be used at a point of sale through an EFTPOS (Electronic Fund Transfer at Point Of Sale) system. Rather than operating as a credit card transaction, which would typically need to go through a credit card issuer system, an EFTPOS transaction could be received by transaction processing network 120 and routed to the appropriate bank holding the account.

In some embodiments, transaction processing network 120 may provide transaction processing service between user 105 and one or more financial service provider 130 through financial transaction system 140, such as a cashing system 150 (e.g., ATM) or a point-of-sale (POS) system 160. Consistent with the present disclosure, transaction processing network 120 receives one or more requests for processing transactions initiated by user 105 (e.g., by a card swipe, a mobile payment, an online payment, or the like) or financial transaction system 140. In the disclosed embodiments, transaction processing network 120 may be developed and operated by a third-party service provider authorized by financial service provider 130 to process financial transactions. In other embodiments, Transaction processing network 120 may be associated with one or more financial service provider 130 for processing financial transactions.

Transaction processing network 120 may include one or more components that perform processes consistent with the disclosed embodiments. For example, transaction processing network 120 may include one or more computers (e.g., server computers, database systems, etc.) that execute software instructions programmed to perform aspects of the disclosed embodiments, such as collecting data regarding transaction requests, processing transaction requests according to one or more transaction rules, processing authentication requests, authorizing transactions, transmitting authorization responses, or settling completed financial transactions.

In some embodiments, transaction processing network 120 may provide a connectivity infrastructure for enabling communication among the various entities and financial transaction system 140 and for processing transactions and/or payment transfers. In some embodiments, transaction processing network 120 may be implemented as part of or in conjunction with a Local Area Network (LAN) or a Wide Area Network (WAN) (such as the internet), and may be a single network or a combination of networks. In some embodiments, transaction processing network 120 may be implemented as a single type of network or a combination of different types of networks (e.g., networks for wireline and/or wireless communications). In some embodiments, transaction processing network 120 may also utilize cloud computing technologies (e.g., for storage, caching, or the like). In some embodiments, transaction processing network 120 can be national, international, or both. It should be noted that transaction processing network 120 is not limited to the above examples, and system 100 may implement any type of network that allows the entities (shown and not shown) included in FIG. 1 to exchange data and information.

Financial service provider 130 may be an entity that provides financial services. For example, financial service provider 130 may be a bank, a check clearinghouse, or another type of financial service entity that configures, offers, provides, and/or manages financial service accounts, such as checking accounts, savings accounts, debit card accounts, credit card accounts, loyalty accounts, etc. These financial service accounts may be used by user 105 to purchase goods and/or services. Financial service provider 130 may include one or more components that perform processes consistent with the disclosed embodiments. The computer systems of financial service provider 130 may be communicatively connected to computer systems in transaction processing network 120. In some embodiments, one or more components in both financial service provider 130 and transaction processing network 120 may cooperate to perform processes consistent with the disclosed embodiments.

Financial transaction system 140 may include one or more of cashing system 150 or POS system 160. Cashing system 150 may be implemented as a computer or other electronic device operable to receive a cash withdrawal transaction request from a user device 110. In some embodiments, cashing system 150 may be implemented as an automated teller machine (ATM) configured to receive data associated with user 105. In other embodiments, cashing system 150 may be implemented at one or more retail locations. Transaction processing network 120 associated with cashing system 150 may receive an account number from user 105 (e.g., by a card swipe) and transmit a cash withdrawal transaction request to transaction processing network 120. The processor associated with cashing system 150 may also receive a cash withdrawal transaction request from user device 110 (e.g., an authenticated smartphone) associated with user 105 through an application program interface (API). Cashing system 150 may be configured to receive instructions from transaction processing network 120 for dispensing cash to user 105.

POS system 160 may be a computer system or other electronic device operable to transmit a POS transaction request for completing a financial transaction using a cash substitute. For example, POS system 160 may include a POS machine. The POS machine may receive an account number (e.g., by a card swipe, a chip-card insertion, a contactless-card tap, or the like) from user 105. In another example, POS system 160 may include a mobile payment machine that may receive the account number (e.g., by receiving an NFC tap, scanning a QR code, or the like) from user device 110 that provides a digital wallet (e.g., Apple Pay®, Google Pay®, Samsung Pay®, or the like). After receiving the account number, POS system 160 may transmit a POS transaction request that includes the account number to transaction processing network 120 or financial service provider 130 for identifying a financial account associated with user 105. In some embodiments, transaction processing network 120 or financial service provider 130 may send an additional request to POS system 160 to receive an identifier (e.g., a PIN number) for some types of transactions (e.g., a debit card transaction). POS system 160 may receive the identifier from user 105 (e.g., by receiving a keypad input) or user device 110 (e.g., by receiving a touchscreen input) and send the identifier to transaction processing network 120 to proceed the transaction. After the transaction being authorized by transaction processing network 120 or financial service provider 130, POS system 160 may receive an indication (e.g., a receipt, a text message, a push notification, an information page, or the like) from transaction processing network 120 that payment is authorized.

In some embodiments, POS system 160 may also be operable to split the monetary amount of the POS transaction request into more than one portion and create a corresponding number of POS transaction requests for completing the financial transaction using any combination of cash or one or more cash substitutes, which may allow a customer to utilize more than one mode of payment to pay for goods or services. In this case, POS system 160 may split the monetary amount and generate a corresponding number of POS transaction requests with the portions of the monetary amount. POS system 160 may then process each of the POS transaction requests.

In some embodiments, POS system 160 may be implemented as an attended machine (e.g., by a cashier or clerk) or an automated kiosk (e.g., by user 105 actuating a screen or buttons on an unmanned or cashier-less kiosks) operable to transmit a request for processing payment of the transaction to transaction processing network 120. In some embodiments, POS system 160 may be implemented as a personal computer, online terminal, or mobile device operating a software application configured to generate a transaction request and transmit the POS transaction request to transaction processing network 120. In some embodiments, POS system 160 may be a retail point-of-sale device, e-commerce website, or mobile application configured to receive account information.

In some embodiments, user 105 may initiate an electronic payment using user device 110. For example, user device 110 may be installed with applications such as Apple Pay® or Zelle®, which can be used to initiate a payment or fund transfer. User device 110 may be a mobile phone, a personal computer, a wearable device (e.g., a smartwatch, smart glasses, etc.), a messaging device, a gaming console, a tablet computer, a personal digital assistant, or the like.

Mobile transaction cloud 170 may provide a connectivity infrastructure for enabling communication among financial service provider 130 via transaction processing network 120, financial transaction system 140, and user device 110. Mobile transaction cloud 170 may be implemented using a wireless network, a cellular network, a satellite network, or the like. Mobile transaction cloud 170 may serve, for example, as a second communication channel, separate from the communication between transaction processing network 120 and financial transaction system 140, for verifying information during an initial registration process or during each transaction request to prevent fraudulent activity, in a manner consistent with the disclosed embodiments. In some embodiments, mobile transaction cloud 170 may work in conjunction with user device 110 to verify information using known techniques such as multi-factor authentication, biometric authentication (e.g., a fingerprint scan, an iris scan, face recognition, etc.), or the like.

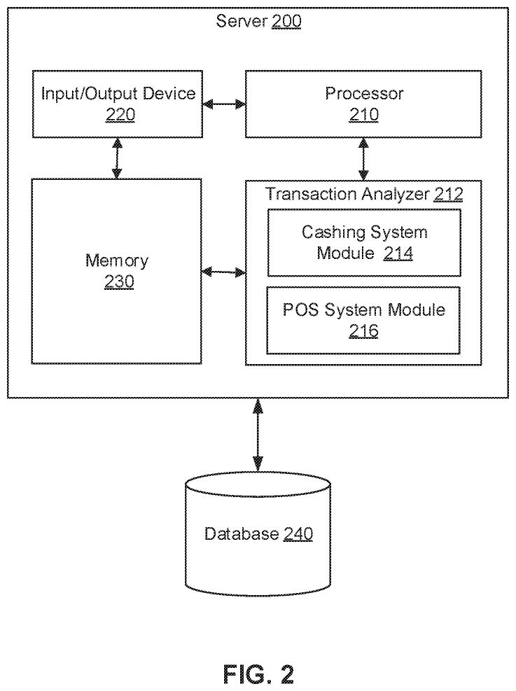

FIG. 2 is a block diagram of an example server computer system 200 (referred to as “server 200” hereinafter) used in system 100, consistent with the disclosed embodiments. For example, server 200 may be used in transaction processing network 120 or financial service provider 130. Server 200 may be one or more computing devices configured to execute software instructions stored in memory to perform one or more processes consistent with the disclosed embodiments. For example, server 200 may include one or more memory devices for storing data and software instructions and one or more hardware processors to analyze the data and execute the software instructions to perform server-based functions and operations (e.g., back-end processes).

In FIG. 2, server 200 includes a hardware processor 210, an input/output (I/O) device 220, and a memory 230. It should be noted that server 200 may include any number of those components and may further include any number of any other components. Server 200 may be standalone, or it may be part of a subsystem, which may be part of a larger system. For example, server 200 may represent distributed servers that are remotely located and communicate over a network.

Processor 210 may include or one or more known processing devices, such as, for example, a microprocessor. In some embodiments, processor 210 may include any type of single or multi-core processor, mobile device microcontroller, central processing unit, etc. In operation, processor 210 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 230, processor 210, or elsewhere.

I/O device 220 may be one or more devices configured to allow data to be received and/or transmitted by server 200. I/O device 220 may include one or more customer I/O devices and/or components, such as those associated with a keyboard, mouse, touchscreen, display, etc. I/O device 220 may also include one or more digital and/or analog communication devices that allow server 200 to communicate with other machines and devices, such as other components of system 100. I/O device 220 may also include interface hardware configured to receive input information and/or display or otherwise provide output information. For example, I/O device 220 may include a monitor configured to display a customer interface.

Memory 230 may include one or more storage devices configured to store instructions used by processor 210 to perform functions related to disclosed embodiments. For example, memory 230 may be configured with one or more software instructions associated with programs and/or data.

Memory 230 may include a single program that performs the functions of the server 200, or multiple programs. Additionally, processor 210 may execute one or more programs located remotely from server 200. Memory 230 may also store data that may reflect any type of information in any format that the system may use to perform operations consistent with disclosed embodiments. Memory 230 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Consistent with the disclosed embodiments, server 200 includes transaction analyzer 212 configured to receive a transaction request and orchestrate one of cashing system module 214 or POS system module 216 for processing the transaction request. Transaction analyzer 212 may be implemented as software (e.g., program codes stored in memory 230), hardware (e.g., a specialized chip incorporated in or in communication with processor 210), or a combination of both. Transaction analyzer 212 may include a cashing system module 214 and a POS system module 216. Cashing system module 214 may be configured to communicate with cashing system 150 to input or output transaction data related to cash (e.g., depositing or withdrawing case, cashback at point of sale, or the like). POS system module 216 may be configured to communicate with POS system 160 to input or output transaction data unrelated to cash (e.g., payments, fund transfers, or the like). In some embodiments, cashing system module 214 and/or a POS system module 216 may be organized or arranged separately from transaction analyzer 212. In further embodiments, cashing system module 214 and POS system module 216 may be combined into one module serving the functions of both modules.

Server 200 may also be communicatively connected to one or more databases 240. For example, server 200 may be communicatively connected to database 240. Database 240 may be a database implemented in a computer system (e.g., a database server computer) in transaction processing network 120 or financial service provider 130. Database 240 may include one or more memory devices that store information and are accessed and/or managed through server 200. By way of example, database 240 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 240. Alternatively, database 240 may be located remotely from the server 200. Database 240 may include computing components (e.g., database management system, database server, etc.) configured to receive and process requests for data stored in memory devices of database 240 and to provide data from database 240.

In an example, transaction analyzer 212 may include instructions to call an API for processing transactions for a compromised account associated with user 105. In some embodiments, the API may communicate with financial service provider 130 to verify whether any transaction through the compromised account may be conducted against a database of account holders at financial service provider 130. If such a transaction is permitted to be conducted, the services related to the API may generate authorization information related to the transaction through the compromised account. In some embodiments, the authorization information may be transmitted (e.g., via a mobile device application, a text message, a phone call, or the like) to user device 110 to be presented (e.g., displayed as text or graph, or played as sound) to user 105. The authorization information may include one or more of, for example, a first name, last name, account name, phone number, email address, passphrase, or a temporary identifier. User 105 may use the authorization information to complete the transaction despite the account being compromised.

For example, user 105 may enter the authorization information into POS system 160 (or cashing system 150), which may further transmit the authorization information to POS system module 216 (or cashing system module 214) of server 200. Once receiving the authorization information, the API may verify whether the authorization information received by POS system module 216 (or cashing system module 214) matches the authorization information generated by the services related to the API. If so, transaction analyzer 212 may approve the transaction through the compromised account, and the API may communicate with financial service provider 130 again to complete the transaction. On the other hand, if the API determines that the authorization information received by POS system module 216 (or cashing system module 214) does not match with the authorization information generated by the services related to the API, transaction analyzer 212 may reject the transaction to protect the compromised account.

For example, transaction analyzer 212 may generate a temporary identifier to be included in the authorization information. The temporary identifier may be a series of random characters in any form, for example, alphanumeric, alphabetic, numeric, text, hash-based, or binary. The temporary identifier may be generated by, for example, a pseudo-random generator. The temporary identifier may only be used for the current transaction and may expire after a preset interval (e.g., 2 minutes) of time. By using the temporary identifier, the transaction may be conducted despite the fact that the account is compromised while maintaining the security of the account for user 105.

In some embodiments, transaction analyzer 212 may transmit one or more transaction rules to cashing system 150 or POS system 160 in FIG. 1 for different transaction types. For example, POS system 160 may receive two transaction rules, one from cashing system module 214 for determining a cash payment amount or a cash withdrawal amount (e.g., in a transaction requesting for cashback), and the other from POS system module 216 for a card payment amount.

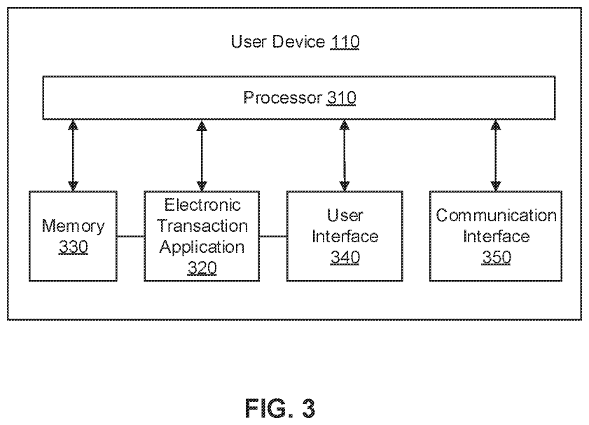

FIG. 3 is a block diagram of an example user device 110 used in system 100, consistent with the disclosed embodiments. As shown in FIG. 3, user device 110 may include a hardware processor 310, an electronic transaction application 320, a memory 330, a user interface 340, and a communication interface 350. In some embodiments, processor 310 may be similar to processor 210, and memory 330 may be similar to memory 230.

Processor 310 may include a digital signal processor, a microprocessor, or another appropriate processor to facilitate the execution of computer instructions encoded in a computer-readable medium. Processor 310 may be configured as a separate processor module dedicated to making an electronic payment. Alternatively, processor 310 may be configured as a shared processor module for performing other functions of user device 110 unrelated to the disclosed methods for making an electronic payment. In some embodiments, processor 310 may execute computer instructions (e.g., program codes) stored in memory 330, and may perform functions in accordance with example techniques described in this disclosure.

Memory 330 may include any appropriate type of mass storage provided to store information that processor 310 may need to operate. Memory 330 may be a volatile or non-volatile, magnetic, semiconductor, tape, optical, removable, non-removable, or another type of storage device or tangible (i.e., non-transitory) computer-readable medium including, but not limited to, a ROM, a flash memory, a dynamic RAM, and a static RAM. Memory 330 may be configured to store one or more computer programs that may be executed by processor 310 to perform the disclosed functions for making an electronic payment.

Electronic transaction application 320 may be a module dedicated to performing functions related to initiating an electronic transaction (e.g., a payment or fund transfer). Electronic transaction application 320 may be configured as hardware, software, or a combination thereof. For example, electronic transaction application 320 may be implemented as computer code stored in memory 330 and executable by processor 310. As another example, electronic transaction application 320 may be implemented as a special-purpose processor, such as an application-specific integrated circuit (ASIC), dedicated to make an electronic payment. As yet another example, electronic transaction application 320 may be implemented as an embedded system or firmware, and/or as part of a specialized computing device.

User interface 340 may include a graphical interface (e.g., a display panel), an audio interface (e.g., a speaker), or a haptic interface (e.g., a vibration motor). For example, the display panel may include a liquid crystal display (LCD), a light-emitting diode (LED), a plasma display, a projection, or any other type of display. The audio interface may include microphones, speakers, and/or audio input/outputs (e.g., headphone jacks).

User interface 340 may also be configured to receive input or commands from user 105. For example, the display panel may be implemented as a touch screen to receive input signals from the user. The touch screen includes one or more touch sensors to sense touches, swipes, and other gestures on the touch screen. The touch sensors may sense not only a boundary of a touch or swipe action but also a period of time and a pressure associated with the touch or swipe action. Alternatively, or additionally, user interface 340 may include other input devices such as keyboards, buttons, joysticks, and/or trackballs. User interface 340 may be configured to send the user input to processor 310 and/or electronic transaction application 320.

Communication interface 350 can access a network (e.g., mobile transaction cloud 170) based on one or more communication standards, such as WiFi, LTE, 2G, 3G, 4G, 5G, etc. In some embodiments, communication interface 350 may include a near field communication (NFC) module to facilitate short-range communications between user device 110 and other devices. In other embodiments, communication interface 350 may be implemented based on radio-frequency identification (RFID) technology, an infrared data association (IrDA) technology, an ultra-wideband (UWB) technology, a Bluetooth® technology, or other technologies.

User device 110 is not always needed when user 105 conducts financial transactions (e.g., a card-based transaction). In some embodiments, user 105 may use user device 110 to initiate an electronic payment without using a physical card. For example, in one embodiment, processor 310 or electronic transaction application 320 may display, on user interface 340, payment information (e.g., a name, an account number, a date, a verification code, etc.) for user 105 to confirm (e.g., by entering authentication information, biometric authentication, or the like). When payment information is confirmed, processor 310 may send transaction data via communication interface 350 to server 200 (e.g., through financial transaction system 140 or mobile transaction cloud 170) for processing. After receiving the transaction data (e.g., through cashing system module 214 or POS system module 216), server 200 may authenticate (e.g., by transaction analyzer 212) the payment information included in the transaction data and authorize the payment.

With server 200 as shown and described in FIG. 2 and user device as shown and described in FIG. 3, this disclosure provides systems and methods for processing financial transactions using compromised financial accounts due to data breaches. A data breach may occur to a financial account belonging to user 105. For example, an account number (e.g., a credit or debit card number) of the financial account may be compromised and exposed to a malicious third party. Consistent with the embodiments of this disclosure, to protect the security of the financial account, financial service provider 130 may lock (“freeze”) the financial account once detecting that the financial account is compromised. Any transaction through the compromised account number may be declined or halted for further verification. Financial service provider 130 may issue a replacement account number (e.g., by issuing a new physical card) to user 105, which may be used after user 105 receives it and activate it. However, in a transition period between when the compromised account number is frozen and when user 105 receives the replacement account number, user 105 may not be able to use the financial account for many types of transactions, such as, for example, recurring transactions (e.g., for utility bills), in-person transactions (e.g., a card-swipe transaction or a mobile payment), or online transactions.

To mitigate the inconvenience for user 105 of being unable to use the compromised account number in some scenarios (e.g., in an in-person transaction or online transaction), financial service provider 130 may notify user 105 of the data breach and provide an option to user 105, which may allow user 105 to conduct limited types of transactions using the compromised account number. Financial service provider 130 may offer an option (e.g., by sending a request through transaction processing network 120 and mobile transaction cloud 170 to user device 110) to user 105. If user 105 opts in such an option, authorization data may be generated and recorded (e.g., in database 240) in system 100 to indicate that user 105 has opted in the option. If user 105 does not opt in or opts out later, the authorization data may be updated (e.g., by changing a flag value in database 240) to reflect that.

In some embodiments, when user 105 is conducting some types of transactions (e.g., including in-person or online transactions but excluding recurring transactions) using the compromised account number (e.g., by swiping the compromised card on a POS system 160), server 200 in system 100 may determine whether the authorization data exists (e.g., stored in database 240) to indicate that the transaction can be authorized. If the authorization data exists, server 200 may generate a temporary identifier (e.g., a one-time PIN) for authorizing the transaction and present it to user 105 on user device 110. Further, transaction processing network 120 or financial service provider 130 may cause (e.g., by sending instruction data by server 200) financial transaction system 140 (e.g., POS system 160) to prompt user 105 to input the temporary identifier. User 105 may input the presented temporary identifier into financial transaction system 140 (e.g., by using a keypad of a POS machine of POS system 160), which may then be transmitted to transaction processing network 120. A processing computer system (e.g., server 200) having transaction analyzer 212 may compare the user-input temporary identifier with the generated temporary identifier. The processing computer system may be in transaction processing network 120 or financial service provider 130. If both identifiers match, the transaction may be approved, and financial service provider 130 may process the transaction data (e.g., forwarded by transaction processing network 120 from financial transaction system 140) to complete the transaction. After the transaction is completed, the processing computer system may set the temporary identifier as expired so that no further transaction through the compromised account number can be authorized using the same temporary identifier again. By doing so, user 105 may use the compromised account number in limited situations without waiting for the replacement account number, while data security of user 105's financial account in financial service provider 130 may be maintained.

In some embodiments, financial service provider 130 may further provide the replacement account number in a digital form (e.g., to be added to a digital wallet provided in user device 110). User 105 may use the replacement account number for some types of transactions (e.g., including online or recurring transactions but excluding the in-person transactions) immediately without waiting for the replacement account number in the physical form (e.g., in the form of a physical card). In some embodiments, financial service provider 130 may provide the replacement account number in the digital form no matter whether user 105 opts in the option as described above. In some embodiments, financial service provider 130 may provide the replacement account number in the digital form only when user 105 will use some types of transactions that are not allowed by the option.

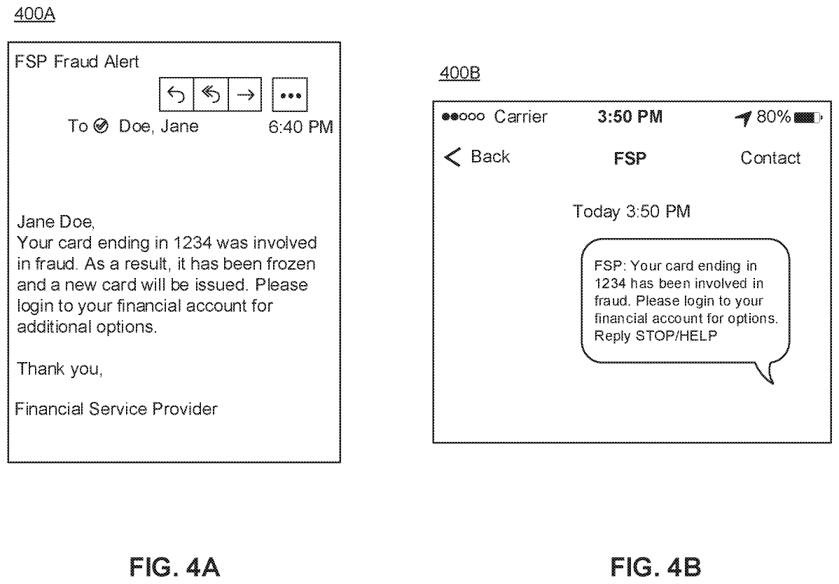

FIGS. 4A-4B depict example notifications 400A and 400B presented on user device 110, consistent with the disclosed embodiments. For example, user device 110 may be a smartphone associated with user 105, and notification 400A or 400B may be displayed on user interface 340 (e.g., a display panel or a touchscreen). Notification 400A may be an email, and notification 400B may be a message (e.g., a text message, a multimedia message, an in-app message, or the like).

As shown in FIGS. 4A-4B, user 105 may be an individual named “Jane Doe.” User 105 may have a financial account with financial service provider 130 that may be named as “Financial Service Provider” or “FSP.” An account number ending in 1234 may be associated with the financial account. For example, the account number may be provided by FSP in a physical form (e.g., a credit or debit card). When a data breach occurs, the account number ending in 1234 may be compromised, and FSP may freeze the account number, identify user 105 associated with the account number 1234 (e.g., from data records in database 240), and send notification 400A, 400B, or both to user device 110 for notifying user 105 that the account number was frozen. Before further actions being taken, all transactions through the compromised account number ending in 1234 will be declined by either transaction processing network 120 or financial service provider 130.

In some embodiments, user device 110 may be associated with user 105 for security. That is, user device 100 may be linked to user 105 to ensure that any communication to and from user device 110 is intended for user 105. For example, user device 110 may be associated with user 105 when user 105 logs in an email address associated with the account number on user device 110, inserts a SIM card of a phone number associated with the account number to user device 110, or logs in an application (e.g., a mobile banking application) provided by FSP on user device 110, or the like. After viewing notification 400A or 400B, user 105 may log in his/her financial account with FSP to explore additional options. For example, user 105 may log in the financial account on user device 110 (e.g., through a web browser or the application provided by FSP).

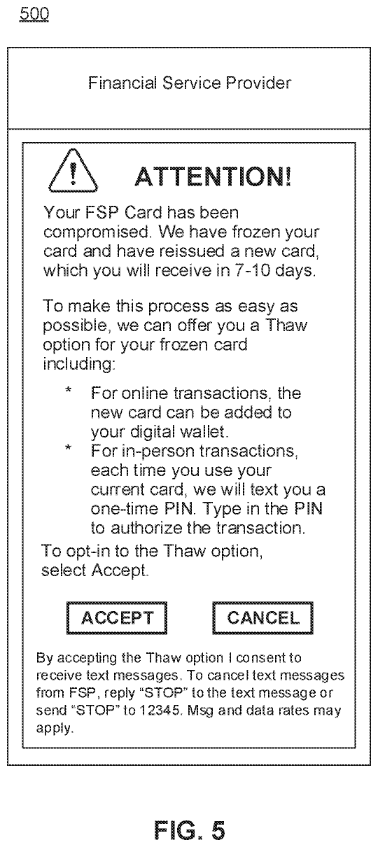

FIG. 5 depicts an example notification 500 showing a request presented on user device 110, consistent with the disclosed embodiments. For example, notification 500 may be displayed on user interface 340. In some embodiments, notification 500 may be displayed as a web page, an email, or an in-app notice in the application provided by FSP.

As shown in FIG. 5, notification 500 essentially requests user 105 to opt in an option, termed as “Thaw.” If user 105 agrees to opt in the “Thaw” option, FSP may provide a new account number different from the compromised account number, which may be added to user 105's digital wallet. For example, user 105 may add the new account number into a digital wallet by entering the new account number along with other information (e.g., user 105's name, billing address, an expiration date of the account number, a verification code, or the like) into a digital wallet application. The new card number may allow user 105 to conduct online transactions but not allow user 105 to conduct unallowed types of transactions (e.g., PIN-required transactions). The “Thaw” option may further provide a one-time PIN associated with the current card number. By using the one-time PIN, the compromised account number may be unlocked to allow user 105 to conduct in-person transactions. Under the “Thaw” option, the compromised account number may still be locked for unallowed types of transactions (e.g., non-in-person transactions). In some embodiments, if user 105 rejects to opt in the “Thaw” option, FSP may still provide the new card number to user 105 for online transactions.

In some embodiments, even though not shown in FIG. 5, the new card number provided by FSP may also be used for recurring transactions (e.g., utility bills). In some embodiments, the one-time PIN may also be used for online transactions. It should be noted that this disclosure does not limit the specific configurations of the types of transactions the “Thaw” option may be used in.

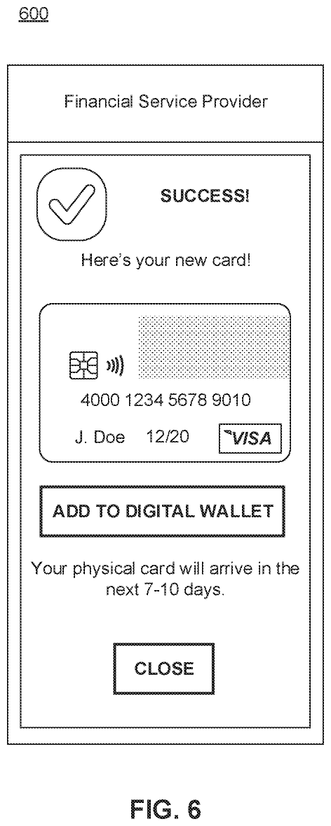

FIG. 6 depicts an example notification 600 showing a replacement account number presented on user device 110, consistent with the disclosed embodiments. For example, notification 600 may be displayed on user interface 340. In some embodiments, notification 600 may be displayed as a web page, an email, or an in-app notice in the application provided by FSP.

Notification 600 may be displayed after user 105 rejects to opt in the “Thaw” option as provided in notification 500. In this case, FSP provides the new account number in a digital form and an option to add it to a digital wallet. User 105 may immediately use the new account number in the types of transactions (e.g., online transactions, recurring transactions, or both) allowed by the “Thaw” option. The new card with the new account number will be delivered to user 105 in a physical mail, which may take several days as indicated by notification 600.

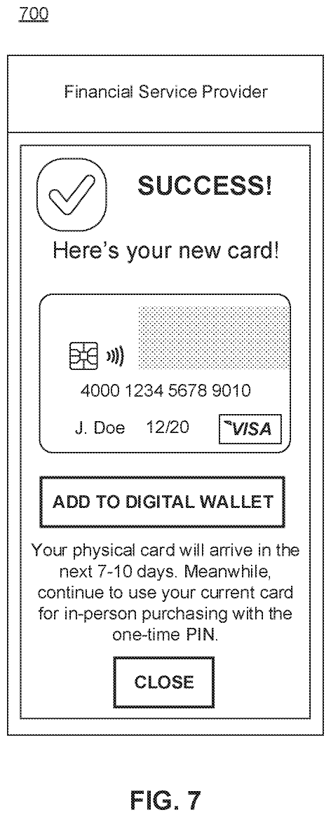

FIG. 7 depicts an example notification 700 showing a confirmation of authorization presented on user device 110, consistent with the disclosed embodiments. For example, notification 700 may be displayed on user interface 340. In some embodiments, notification 700 may be displayed as a web page, an email, or an in-app notice in the application provided by FSP.

Notification 700 may be displayed after user 105 agrees to opt in the “Thaw” option as provided in notification 500. In this case, similar to the case where user 105 rejects to opt in the “Thaw” option, FSP may still provide the new account number in a digital form and an option to add it to a digital wallet. Besides, notification 700 presents a confirmation of authorization to user 105 that the compromised account number will be authorized to conduct some allowed types of transactions (e.g., in-person transactions) in the future in combination with the one-time PIN provided by the “Thaw” option.

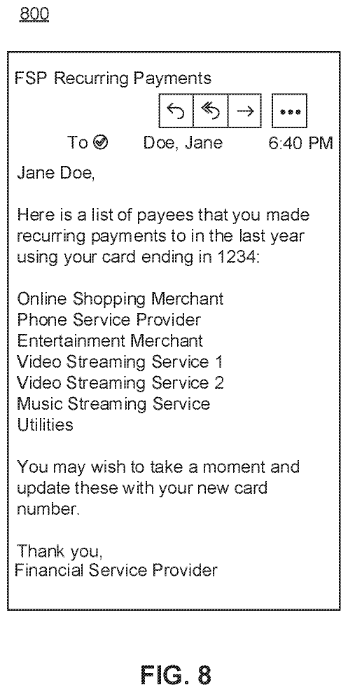

FIG. 8 depicts an example notification 800 showing a list of recurring transactions presented on user device 110, consistent with the disclosed embodiments. For example, notification 800 may be displayed on user interface 340. In some embodiments, notification 800 may be displayed as a web page, an email, or an in-app notice in the application provided by FSP.

Notification 800 may be displayed after FSP provides the new account number to user 105. FSP may retrieve (e.g., from database 240) records of recurring transactions associated with the compromised account number in a predetermined period of time (e.g., within a previous year) and present them to user 105 in notification 800. As shown in FIG. 7, the recurring transactions may include transactions with an online shopping merchant, a phone service provider, an entertainment merchant, a video streaming service provider, a music streaming service provider, a utility company, or the like. Notification 800 may be used to notify user 105 to update payment information associated with the recurring transactions with the new account number to avoid unexpected payment failures.

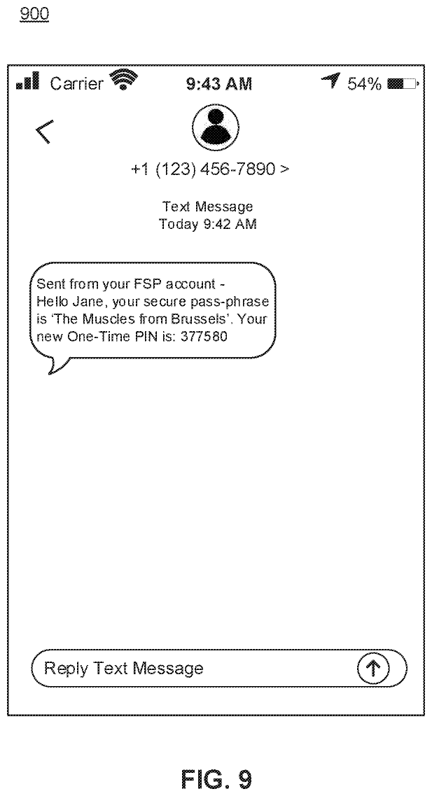

FIG. 9 depicts an example notification 900 showing a temporary identifier presented on user device 110, consistent with the disclosed embodiments. For example, notification 900 may be displayed on user interface 340. In FIG. 9, notification 900 may be displayed as a text message.

In some embodiments, when user 105 opts in the “Thaw” option as provided in notification 500, the one-time PIN provided by the “Thaw” option may be enabled. When user 105 is conducting a transaction (e.g., an in-person card-swipe transaction) allowed by the “Thaw” option, notification 900 may be sent by FSP and displayed on user device 110 after the transaction is initiated. For example, when user 105 swipes or inserts the compromised physical card at POS system 160, financial transaction system 140 may receive the compromised account number, generate transaction data, and send the transaction data (including the compromised account number) to transaction processing network 120 that may further forward the transaction data to financial service provider 130. Server 200 (e.g., in transaction processing network 120 or financial service provider 130) may receive the compromised account number and determine (e.g., by checking records in database 240) whether this account number is compromised. If server 200 determines that the received account number is compromised, it may further determine (e.g., by checking records in database 240) whether the “Thaw” option is opted in by user 105. If server 200 determines that user 105 has opted in the “Thaw” option, it may generate a one-time PIN (e.g., “377580” as shown in FIG. 9) and send notification 900 (e.g., via mobile transaction cloud 170) including the one-time PIN to user device 110. Also, server 200 may further send instruction data (e.g., via mobile transaction cloud 170) to POS system 160 to cause it to prompt user 105 to enter a PIN to proceed the transaction.

If user 105 correctly inputs the one-time PIN shown in notification 900 to POS system 160, POS system 160 may send the entered PIN to server 200. Server 200 may determine whether the entered PIN is the same as the generated PIN. If the two PINs are the same, server 200 may approve the transaction, and financial service provider 130 (e.g., FSP) may complete the transaction using the transaction data. Otherwise, server 200 may reject the transaction. In some embodiments, after rejecting the transaction, server 200 may generate a new one-time PIN (not shown in FIG. 9) and send a new notification 900 (e.g., via mobile transaction cloud 170) including the new one-time PIN to user device 110 to retry authorizing the transaction, in case user 105 mistyped the previous one-time PIN.

In some embodiments, the “Thaw” option may further provide automatic credit line adjustment. For example, if the financial account of user 105 is near or above a credit limit, while user 105 is conducting the transaction allowed by the “Thaw” option where the amount of transaction would have been declined if the credit line is not increased, server 200 may retrieve historical data (e.g., from database 240) of user 105 to evaluate whether an automatic credit line increase can be performed. For example, the historical data may include payment history, average monthly transaction amount, an income of user 105, number of late payments, credit scores, or the like. If server 200 determines that user 105 has a good relationship with financial service provider 130 and high creditworthiness, it may raise the credit line limit of user 105's financial account without user 105's intervention. By doing so, the transaction may be completed automatically, and user experience may be further improved.

In some embodiments, if user 105 opts in the “Thaw” option as provided in notification 500, the one-time PIN provided by the “Thaw” option may be enabled for a limited period of time. For example, the limited period of time may be manually set by user 105 or financial service provider 130. In an example, the limited period of time may be the time period between user 105 opting in the “Thaw” option and user 105 receiving the new account number in a physical mail. In some embodiments, if user 105 opts in the “Thaw” option as provided in notification 500, the one-time PIN provided by the “Thaw” option may be enabled for an unlimited time. For example, the one-time PIN may be enabled forever until user 105 disables it.

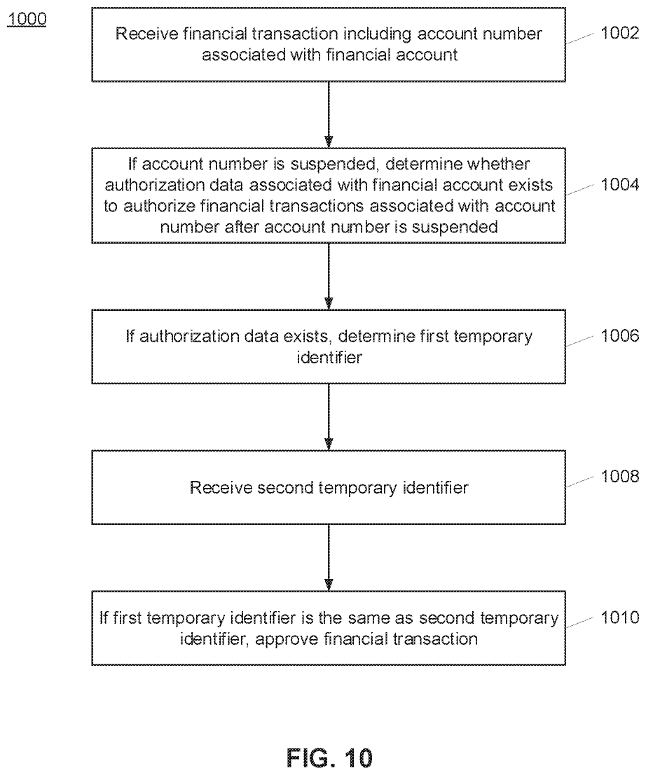

FIG. 10 is a flowchart of example process 1000 for processing a financial transaction in system 100, consistent with the disclosed embodiments. Process 1000 may be a “back-end” process performed by a computer-implemented system (e.g., server 200) in transaction processing network 120 or financial service provider 130. The computer-implemented system may include a memory (e.g., memory 230) that stores instructions and a processor (e.g., processor 210) programmed to execute the instructions to implement process 1000. Process 1000 may be connected to the operations shown and described in FIGS. 4A-9. For example, process 1000 may be implemented as one or more software modules (e.g., an API in transaction analyzer 212) stored in memory 230 and executable by processor 210.

Referring to FIG. 10, at step 1002, the processor may receive a financial transaction including an account number (e.g., the account number ending in 1234 as shown in FIGS. 4A-4B) associated with a financial account. For example, the financial transaction may be a payment transaction (e.g., a purchase transaction), a fund transfer transaction (e.g., transferring funds between accounts), an inquiry transaction (e.g., inquiring account balance at an ATM machine), a cash-related transaction (e.g., depositing or withdrawing cash from an ATM machine), a verification transaction (e.g., by swiping a card to verify original payment method), or the like. It should be noted that the financial transaction may be any transaction that requires the account number, and this disclosure does not limit its embodiments to the examples provided herein.

In some embodiments, the financial transaction may include at least one of an in-person transaction or an online transaction. For example, the in-person transaction may be a transaction where user 105 is present, such as a card-present transaction (e.g., in which a physical card needs to be present) or a digital wallet transaction (e.g., in which the physical card need not be presented). For another example, the online transaction may be a transaction conducted on a website (e.g., an online shopping merchant website) or a mobile application (e.g., a shopping application installed in user device 110). In some embodiments, the processor may be processor 210 of server 200, and the processor may receive the financial transaction from a device in financial transaction system 140.

In some embodiments, the device may be in cashing system 150 or POS system 160. For example, the device may be an attended machine (e.g., an ATM machine) in cashing system 150. For another example, the device may be a POS device in POS system 160, such as a POS terminal machine (e.g., a card-swipe, -insert, or -tap machine), an automated kiosk (e.g., a cashier-less kiosk), or the like.

In some embodiments, when user 105 initiates the financial transaction, the device may receive the account number and generate financial transaction data for the financial transaction. The device may transmit the financial transaction (including the account number) to the processor. The device may receive the account number in various ways, such as, for example, by user 105's swiping, inserting, or tapping a physical card (e.g., a debit card or a credit card) at the device. In some embodiments, the device may receive the account number from user device 110 that provides a digital wallet (e.g., Apple Pay®, Google Pay®, Samsung Pay®, or the like). For example, if both the device and user device 110 are equipped with near-field communication (NFC) chips, the device may receive the account number stored in user device 110 by a tap. For another example, user device 110 may generate a graphic code (e.g., a barcode or QR code) that represents the account number and display it on user interface 340 (e.g., a display panel). If the device is equipped with a scanner (e.g., a barcode scanner or QR code scanner), it may receive the account number from user device 110 by scanning the graphic code.

Still referring to FIG. 10, at step 1004, based on a determination that the account number is suspended, the processor determines whether authorization data associated with the financial account exists to authorize financial transactions associated with the account number after the account number is suspended. For example, the account number may be suspended (e.g., “frozen”) due to a data breach, as shown and described in FIGS. 4A-4B.

In some embodiments, financial service provider 130 (e.g., FSP in FIGS. 4A-9) may determine that the account number is compromised before process 1000 is being performed. Based on a determination that the account number is compromised, the processor may suspend the use of the account number. For example, the processor may update a record in database 240 to indicate that any transaction through the compromised account number will be declined. The processor may further transmit a notification (e.g., notification 400A or 400B) to an apparatus (e.g., user device 110) associated with the financial account indicating that the account number is suspended.

In some embodiments, the authorization data may be data (e.g., a flag value stored in database 240) indicative of that some types of transactions are allowed to be conducted through the compromised account number despite the account number is suspended. For example, the authorization data may be a flag value indicative of user 105 having opted in an option (e.g., the process as shown and described in FIGS. 5-9) that allows limited types of transactions using the compromised account number. If the authorization data exists (e.g., located in database 240 by the processor) and the financial transaction at step 1002 is within the allowed types of transactions (e.g., the in-person transaction, online transaction, or both), the financial transaction may be authorized after the account number is suspended.

In some embodiments, if the processor determines that the authorization data does not exist (e.g., not found in database 240), it may reject the financial transaction after step 1004.

Still referring to FIG. 10, at step 1006, the processor determines a first temporary identifier based on a determination that the authorization data exists. For example, the temporary identifier may be the one-time PIN, as shown and described in FIGS. 5-9. In some embodiments, the first temporary identifier may be a character string including at least one of an alphanumeric character or a special character. In some embodiments, the first temporary identifier may be associated with an individual account, a corporate account, a shared account, or any type of financial account that is not necessarily held by a single natural person.

In some embodiments, the processor (e.g., through transaction analyzer 212) may determine the first temporary identifier using a random generator algorithm (e.g., a pseudo-random generator). The processor may notify user 105 of the first temporary identifier after determining it.

In some embodiments, after determining the first temporary identifier, the processor may transmit (e.g., by communication interface 350 through mobile transaction cloud 170) the first temporary identifier to an apparatus (e.g., user device 110) associated with the financial account. In some embodiments, the processor may transmit the first temporary identifier to the apparatus via one of a text message (e.g., notification 900 in FIG. 9), a push notification (e.g., in user interface 340 of user device 110), an in-app notification (e.g., in an in-app interface of a mobile application installed in user device 110), an email, or a telephone call (e.g., by reading the first temporary identifier through a speaker of user device 110 to user 105).

In some embodiments, the computer-implemented system (e.g., server 200) may notify user 105 of the first temporary identifier without transmitting it. For example, the processor may determine the first temporary identifier using a shared-secret based algorithm. The shared-secret based algorithm may be independently performed by the processor and the apparatus (e.g., user device 110) associated with the financial account to generate identical identifier codes. The shared-secret based algorithm may include, for example, an HMAC-based one-time password (HOTP) algorithm that is based on hash-based message authentication codes (HMAC), a time-based one-time password (TOTP) algorithm, or the like. In the shared-secret based algorithm, a “shared secret” (e.g., a sequence of bytes not exposed to third parties) may be synchronized between devices running the same shared-secret based algorithm for setting up. For example, the processor may convert the shared secret to a QR code, and user 105 may use user device 110 to scan the QR code (e.g., in an authentication application installed in user device 110) to synchronize the shared secret between user device 110 and the processor. After the synchronization, both the processor and user device 110 may independently generate the same identifier code using the same shared-secret based algorithm based on the same shared secret. By doing so, user 105 may examine the first temporary identifier at any time (e.g., by opening the authentication application) without waiting for its transmission from the processor.

In some embodiments, based on a determination that the authorization data exists, the processor may transmit instruction data to the device, wherein the instruction data may enable the device to receive a second temporary identifier from user input. For example, the device may be a POS terminal machine that does not require PIN input in a normal credit card transaction. If the compromised account number in process 1000 is a credit card number, the instruction data sent by the processor may cause the POS terminal machine to display a user interface that prompts user 105 to input an identifier code (e.g., a PIN) for proceeding the financial transaction.

Still referring to FIG. 10, at step 1008, the processor receives a second temporary identifier from the device. For example, user 105 may input the first temporary identifier (e.g., transmitted by the processor to user device 110 or displayed in an authentication application installed in user device 110) to the device (e.g., a POS terminal machine, a cashier-less kiosk, or the like). In some embodiments, if the transaction is an online transaction conducted in a shopping application installed in user device 110, both the apparatus that displays the first temporary identifier and the device that is to receive the second temporary identifier from user 105 may be the same device (e.g., user device 110). When user 105 correctly inputs the first temporary identifier to the device, the second temporary identifier may be the same as the first temporary identifier. When user 105 incorrectly inputs the first temporary identifier to the device, the second temporary identifier may be different from the first temporary identifier.

In some embodiments, if the processor does not receive the second temporary identifier from the device in time, the processor may reject the financial transaction. For example, the processor may determine whether the second temporary identifier is received within a preset time period (e.g., 30 seconds, 1 minute, 2 minutes, or any length of time) timed from when the first temporary identifier is generated. If the second temporary identifier is not received within the preset time period, the processor may reject the financial transaction.

Still referring to FIG. 10, at step 1010, based on a determination that the first temporary identifier is the same as the second temporary identifier, the processor approves the financial transaction. For example, the processor may forward data of the financial transaction to financial service provider 130 to complete the transaction (e.g., to deduct funds from the financial account). In some embodiments, based on a determination that the first temporary identifier is different from the second temporary identifier, the processor may reject the financial transaction.

In some embodiments, after rejecting the financial transaction, the processor may repeat steps 1006-1008 in case user 105 inputs an incorrect temporary identifier. For example, in response to rejecting the financial transaction, the processor may determine a third temporary identifier that is different from the first temporary identifier. The third temporary identifier may be notified to user 105 in a way similar to operations described in step 1006. The processor may then receive a fourth temporary identifier from the device. If the third temporary identifier is the same as the fourth temporary identifier, the processor may approve the financial transaction.

In some embodiments, the authorization data in process 1000 may be obtained in a requesting process. For example, the processor may transmit a request (e.g., notification 500) for the authorization data to the apparatus (e.g., user device 110) after financial service provider 130 detects that the account number is compromised. The processor may receive the authorization data from the apparatus. For example, as shown in FIG. 5, user 105 may receive notification 500 that includes the request for authorization data at user device 110. If user 105 accepts to opt in the process described in FIGS. 5, 7, and 9, the processor may receive the authorization data from user device 110. After receiving the authorization data, the process may generate a replacement account number associated with the financial account. The processor may further transmit the replacement account number to the apparatus (e.g., user device 110). In some embodiments, the apparatus may present the replacement account number to user 105. For example, the replacement account number may be the new account number presented in notifications 600 and 700 in FIGS. 6-7.

In some embodiments, after generating the replacement account number, the computer-implemented system may retrieve one or more recurring transactions associated with the compromised account number and present those recurring transactions to user 105 to remind user 105 to update payment information to avoid unexpected payment errors. For example, the processor may retrieve (e.g., from database 240) information of a recurring transaction (e.g., records shown in notification 800) associated with the account number. The processor may further transmit the information to the apparatus (e.g., user device 110).

In some embodiments, after retrieving the information of the recurring transaction, the processor may further update payment information of the recurring transaction using the replacement account number. For example, the processor may search for the compromised account number in the information of the recurring transaction and automatically replace the compromised account number with the replacement account number. By doing so, the movement of the recurring transaction from the compromised account number to the replacement account number may be automated without user intervention, and user experience may be further improved.

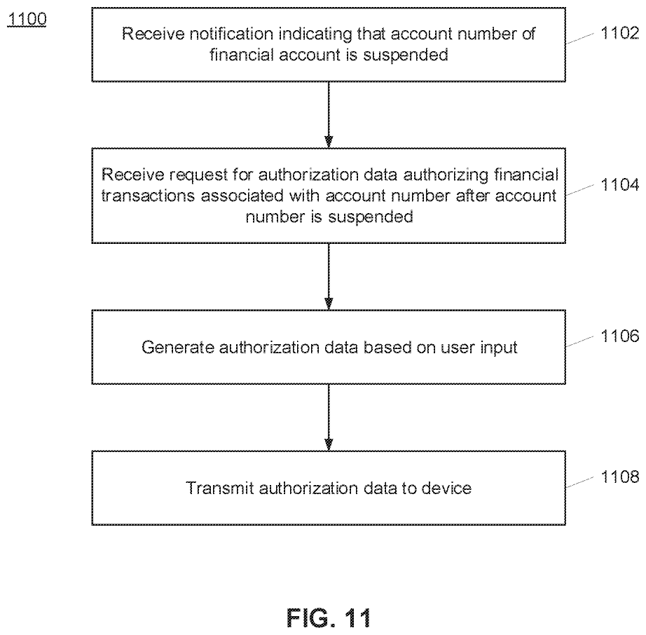

FIG. 11 is a flowchart of an example process 1100 for processing a financial transaction in system 100, consistent with the disclosed embodiments. Process 1100 may be a “front-end” process performed by a computer-implemented system (e.g., user device 110) in system 100. The computer-implemented system may include a memory (e.g., memory 330) that stores instructions and a processor (e.g., processor 310) programmed to execute the instructions to implement process 1100. Process 1100 may be connected to the operations shown and described in FIGS. 4A-9. For example, process 1100 may be implemented as one or more software modules (e.g., an API) stored in memory 330 and executable by processor 310 (e.g., electronic transaction application 320).

Referring to FIG. 11, at step 1102, the processor receives (e.g., through communication interface 350) a notification (e.g., notification 400A or 400B) indicating that an account number (e.g., the account number ending in 1234 as shown in FIGS. 4A-4B) of a financial account is suspended. For example, the account number may be a compromised account number. In some embodiments, the processor may receive the notification from a device (e.g., from server 200 through mobile transaction cloud 170). In some embodiments, the processor may present the notification (e.g., on user interface 340) to user 105.

At step 1104, the processor receives (e.g., through communication interface 350) a request (e.g., the request presented in notification 500) from the device (e.g., server 200) for authorization data authorizing financial transactions associated with the account number after the account number is suspended. The authorization data may be the same authorization data as described in process 1000. In some embodiments, the processor may present the request (e.g., on user interface 340) to user 105. For example, the request may present user 105 an option to opt in (e.g., the process as shown and described in FIGS. 5-9).

At step 1106, the processor generates the authorization data based on user input. The processor may receive the user input via user interface 340 (e.g., a touchscreen). For example, as shown in FIG. 5, if user 105 opts in (e.g., by clicking the “ACCEPT” button in notification 500) the “Thaw” option, the processor may generate the authorization data.

At step 1108, the processor may transmit (e.g., via communication interface 350) the authorization data to the device (e.g., server 200). In some embodiments, after step 1108, the processor may receive a replacement account number (e.g., the replacement account number as described in process 1000) associated with the financial account. In some embodiments, the replacement account number may be configured to approve a recurring transaction (e.g., the recurring transaction as described in process 1000) associated with the account number.

In some embodiments, when user 105 is conducting a financial transaction (e.g., the financial transaction as described in process 1000) that is allowed by the option as described in step 1104, the computer-implemented system may notify user 105 temporary identifiers for authorization. For example, the processor may receive (e.g., through communication interface 350) a first temporary identifier (e.g., the first temporary identifier as described in process 1000) from the device (e.g., server 200) for authorizing a financial transaction associated with the account number. The processor may present (e.g., on user interface 340) the first temporary identifier to a user conducting the financial transaction. In some embodiments, the processor may receive the first temporary identifier via one of a text message (e.g., notification 900 in FIG. 9), a push notification (e.g., in user interface 340), an in-app notification (e.g., in an in-app interface of a mobile application installed in the computer-implemented system), an email, or a telephone call (e.g., by reading the first temporary identifier through a speaker of the computer-implemented system to user 105).

In some embodiments, the computer-implemented system may notify user 105 of temporary identifiers without receiving anything from the device (e.g., server 200). For example, similar to the operations described in step 1006, the processor may determine the first temporary identifier using a shared-secret based algorithm. The device (e.g., server 200) may be configured to determine the same first temporary identifier using the shared-secret based algorithm independently from the at least one processor. After determining the first temporary identifier, the processor may present the first temporary identifier (e.g., on user interface 340) to user 105 conducting the financial transaction.

A non-transitory computer-readable medium may be provided that stores instructions for a processor (e.g., processor 210 or 310) for processing a financial transaction according to the example flowcharts of FIGS. 10-11 above, consistent with embodiments in the present disclosure. For example, the instructions stored in the non-transitory computer-readable medium may be executed by the processor for performing process 1000 or 1100 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system comprising:
a non-transitory computer-readable medium configured to store instructions; and
at least one processor configured to execute the instructions to perform operations comprising:
receiving, from a device, a financial transaction comprising an account number associated with a financial account;
based on a determination that the account number is suspended, determining whether authorization data associated with the financial account exists to authorize financial transactions associated with the account number after the account number is suspended;
based on a determination that the authorization data exists, determining a first temporary identifier;
receiving a second temporary identifier from the device; and
based on a determination that the first temporary identifier is the same as the second temporary identifier, approving the financial transaction.

2. The computer-implemented system of claim 1, wherein the operations further comprise:
based on a determination that the authorization data does not exist, rejecting the financial transaction.

3. The computer-implemented system of claim 1, wherein the operations further comprise:
in response to determining the first temporary identifier, transmitting the first temporary identifier to an apparatus associated with the financial account.

4. The computer-implemented system of claim 3, wherein transmitting the first temporary identifier to the apparatus comprises:
transmitting the first temporary identifier to the apparatus via one of a text message, a push notification, an in-app notification, an email, or a telephone call.

5. The computer-implemented system of claim 1, wherein determining the first temporary identifier comprises:
determining the first temporary identifier using a shared-secret based algorithm, wherein an apparatus associated with the financial account is configured to determine the first temporary identifier using the shared-secret based algorithm independently from the at least one processor.

6. The computer-implemented system of claim 1, wherein the operations further comprise:
based on a determination that the first temporary identifier is different from the second temporary identifier, rejecting the financial transaction.

7. The computer-implemented system of claim 6, wherein the operations further comprise:
in response to rejecting the financial transaction, determining a third temporary identifier;
receiving a fourth temporary identifier from the device; and
based on a determination that the third temporary identifier is the same as the fourth temporary identifier, approving the financial transaction.

8. The computer-implemented system of claim 1, wherein the operations further comprise:
determining whether the second temporary identifier is received within a preset time period timed from when the first temporary identifier is generated; and
based on a determination that the second temporary identifier is not received within the preset time period, rejecting the financial transaction.

9. The computer-implemented system of claim 1, wherein the financial transaction comprises at least one of an in-person transaction or an online transaction.

10. The computer-implemented system of claim 1, wherein the first temporary identifier is a character string comprising at least one of an alphanumeric character or a special character.

11. The computer-implemented system of claim 1, wherein the operations further comprise:
based on a determination that the account number is compromised, suspending use of the account number; and
transmitting a notification to an apparatus associated with the financial account indicating that the account number is suspended.

12. The computer-implemented system of claim 11, wherein the operations further comprise:
transmitting a request for the authorization data to the apparatus;
receiving the authorization data from the apparatus;
generating a replacement account number associated with the financial account; and
transmitting the replacement account number to the apparatus.

13. The computer-implemented system of claim 12, wherein the operations further comprise:
retrieving information of a recurring transaction associated with the account number; and
transmitting the information to the apparatus.

14. The computer-implemented system of claim 13, wherein the operations further comprise:
updating payment information of the recurring transaction using the replacement account number.

15. The computer-implemented system of claim 1, wherein the operations further comprise:
based on a determination that the authorization data exists, transmitting instruction data to the device, wherein the instruction data enables the device to receive the second temporary identifier from user input.

16. A computer-implemented system comprising:
a non-transitory computer-readable medium configured to store instructions; and
at least one processor configured to execute the instructions to perform operations comprising:
receiving, from a device, a notification indicating that an account number of a financial account is suspended;
receiving, from the device, a request for authorization data authorizing financial transactions associated with the account number after the account number is suspended;
based on user input, generating the authorization data; and
transmitting the authorization data to the device.

17. The computer-implemented system of claim 16, wherein the operations further comprise:
receiving, from the device, a replacement account number associated with the financial account, wherein the replacement account number is configured to approve a recurring transaction associated with the account number.

18. The computer-implemented system of claim 16, wherein the operations further comprise:
receiving, from the device, a first temporary identifier for authorizing a financial transaction associated with the account number; and
presenting the first temporary identifier to a user conducting the financial transaction.

19. The computer-implemented system of claim 18, wherein receiving the first temporary identifier comprises:
receiving the first temporary identifier via one of a text message, a push notification, an in-app notification, an email, or a telephone call.

20. The computer-implemented system of claim 16, wherein the operations further comprise:
determining a first temporary identifier for authorizing a financial transaction associated with the account number using a shared-secret based algorithm, wherein the device is configured to determine the first temporary identifier using the shared-secret based algorithm independently from the at least one processor; and
presenting the first temporary identifier to a user conducting the financial transaction.
